(19) United States
(12) Patent Application Publication
(10) Pub. No.: US 2026/0195945 A1
(43) Pub. Date: Jul. 9, 2026

(54) DEVICES THAT EDIT IMAGES, METHODS FOR CONTROLLING DEVICES, AND STORAGE MEDIUMS

(71) Applicant: CANON KABUSHIKI KAISHA, Tokyo (JP)

(72) Inventor: TAKASHI MIZUNO, Tokyo (JP)

(21) Appl. No.: 19/437,323

(22) Filed: Dec. 31, 2025

(30) Foreign Application Priority Data
Jan. 9, 2025 (JP) 2025-003440

(51) Int. Cl. G06T 11/60

(52) U.S. Cl. CPC G06T 11/60

(57) ABSTRACT

Devices that edit images, methods for controlling such devices, and storage mediums are provided herein. An image editing device according to the present disclosure includes one or more processors that operate to execute an editing processing of editing an image in a current developing mode, execute a changing processing of changing the current developing mode to any of a plurality of modes, execute a recording control processing of recording, into a recording region corresponding to the current developing mode, an edit item of editing performed in the current developing mode, and in a case where the plurality of modes include a mode that uses the edit item on the image in common with the current developing mode, execute an application processing of applying the edit item also to a recording region corresponding to the mode that uses the edit item.

### BACKGROUND

### Field of the Technology

The present disclosure relates to one or more embodiments of an image editing device that edits images, control methods for devices, and storage mediums.

### Description of the Related Art

Environments in which high dynamic range (called “HDR” hereinafter) images may be adjusted and displayed have become more common. Along with this, systems that may adjust and display images suited to HDR environments in HDR color gamuts have emerged as well. On the other hand, display environments for conventional standard dynamic range (called “SDR” hereinafter) are still being used, and it is therefore still necessary to adjust and display images suited to SDR environments. Accordingly, systems capable of running while switching between image adjustment and display, which are suited to SDR environments, and image adjustment and display, which are suited to HDR environments, have also emerged.

Japanese Patent Laid-Open No. 2020-025178 describes an information processing apparatus which, when adjusting adjustment parameters that result in an image having properties different between being in an SDR environment and being in an HDR environment, detects whether the adjustment parameters are to be readjusted, and notifies a user to that effect. This makes it possible to reduce the likelihood of an image being generated with properties different from those expected. Image adjustments suited to the SDR environment and the HDR environment, respectively, are made by readjusting the adjustment parameters, which makes it possible to display images corresponding to the properties of the SDR environment and the HDR environment, respectively.

However, in Japanese Patent Laid-Open No. 2020-025178, when an HDR setting (a setting for development) is switched from the SDR environment to the HDR environment, and then switched back from the HDR environment to the SDR environment, adjustment parameters that result in an image having properties different between being in the SDR environment and being in the HDR environment are reset twice. As such, the adjustment parameters originally used in the SDR environment may not be used.

### SUMMARY

One or more embodiments of the present disclosure provide one or more techniques that make it possible to easily provide or more easily provide an image in which more appropriate image adjustments have been made, even when switching settings for development. One or more embodiments of the present disclosure provide one or more techniques to avoid extra reconfiguration steps, for processing state changes efficiently, and/or for providing image editing devices, methods, and storage mediums.

One or more embodiments of an image editing device according to the present disclosure includes one or more processors that operate to execute an editing processing of editing an image in a current developing mode, execute a changing processing of changing the current developing mode to any of a plurality of modes, execute a recording control processing of recording, into a recording region corresponding to the current developing mode, an edit item of editing performed in the current developing mode, and in a case where the plurality of modes include a mode that uses the edit item on the image in common with the current developing mode, execute an application processing of applying the edit item also to a recording region corresponding to the mode that uses the edit item.

According to other aspects of the present disclosure, one or more additional image editing devices, one or more control methods for one or more image editing devices, and one or more storage mediums are discussed herein. Features of the present disclosure will become apparent from the following description of embodiments with reference to the attached drawings. The following description of embodiments is described by way of example.

### BRIEF DESCRIPTION OF THE DRAWINGS

FIG. 1 is a block diagram of at least one embodiment of an image editing device or an electronic device in accordance with one or more aspects of the present disclosure.

FIG. 2 is a diagram illustrating at least one embodiment of an image file in accordance with one or more aspects of the present disclosure.

FIG. 3 is a diagram illustrating at least one embodiment of a table in accordance with one or more aspects of the present disclosure.

FIG. 4 is a flowchart illustrating one or more embodiments of processing by one or more embodiments of a device or an image editing device in accordance with one or more aspects of the present disclosure.

FIG. 5 is a diagram illustrating at least one embodiment of a specific recording method in accordance with one or more aspects of the present disclosure.

FIG. 6 is a diagram illustrating at least one embodiment of an example of a transition in the recording of an edit item in accordance with one or more aspects of the present disclosure.

### DESCRIPTION OF THE EMBODIMENTS

One or more embodiments of this disclosure will be described hereinafter with reference to the accompanying drawings. Note, however, that the constituent elements described in the embodiment(s) are merely examples, and the scope of the present disclosure is not intended to be limited only thereto.

In one or more embodiments, a High Dynamic Range (HDR) setting for development (developing mode; image adjustment mode) may be set in two ways, namely HDR PQ (called simply “HDR” hereinafter) and Standard Dynamic Range (SDR). In a case where the HDR setting for development is switched, edit items that cannot be shared between HDR development and SDR development (for which the same parameters cannot be used for the image) are reset. Changing the setting of the RGB tone curve is an example of an edit item that cannot be shared between HDR development and SDR development. Accordingly, items to be edited are recorded in association with each other for when the setting for development is HDR and when the setting for development is SDR.

Here, gamma processing (γ processing) may be given as an example of an edit item that cannot be shared between HDR development and SDR development. Gamma processing assumed for use in SDR development is, for example, γ processing that applies a gamma characteristic (γ characteristic) of 1/2.2. On the other hand, gamma processing assumed for use in HDR development is, for example, γ processing that applies a γ characteristic, such as the Perceptual Quantization (PQ) method. Image adjustment using these γ characteristics are often performed during or after RAW data development processing, for example. Additionally, in image adjustment, settings for adjustment parameters specified as desired by the user or adjustment parameters prepared separately are often applied.

Image adjustments including γ processing, adjustments made using user-specified or separately-prepared adjustment parameters, and the like are generally performed using either an image displayed in SDR or an image displayed in HDR. On the other hand, image adjustments and display may be performed while switching between image adjustment and display suitable for SDR environments and image adjustments and display suitable for HDR environments as desired. However, the characteristics of images with image adjustments suited to SDR environments and images with image adjustments suited to HDR environments differ greatly. Accordingly, for example, if the adjustment parameters are used as-is when the image adjustment is switched, or if the adjustment parameters specified as desired by the user or prepared separately are set, the image may take on different characteristics than expected. Accordingly, when adjustment parameters that result in an image having different properties in the SDR environment and the HDR environment are used for adjustment, it is necessary to respond by prompting the user to make a readjustment in the display environment being switched to, rather than applying the adjustment parameters at the time the display environment is switched.

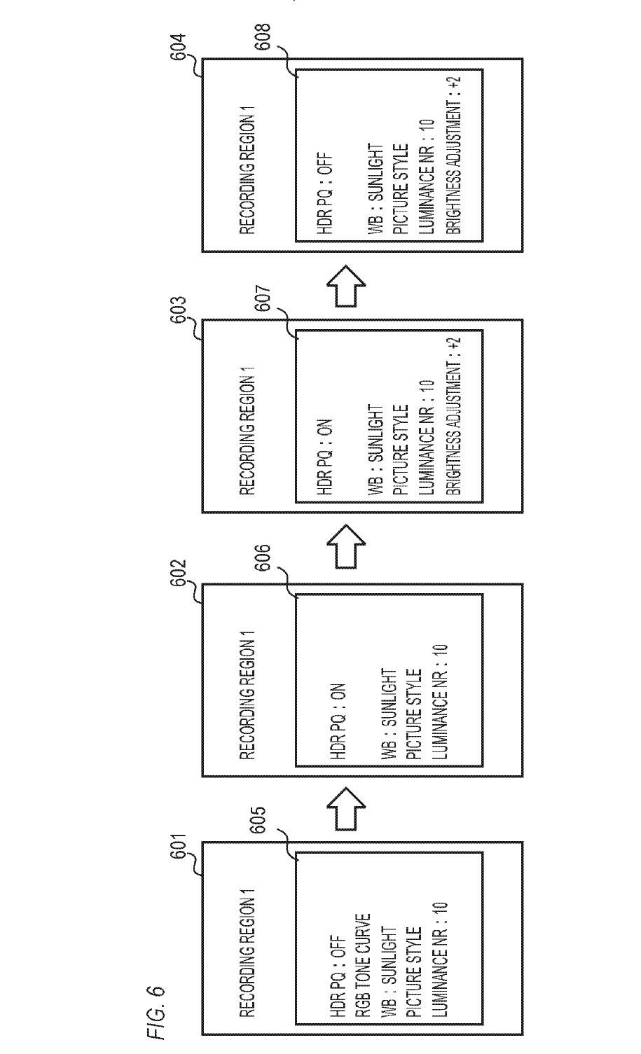

FIG. 6 is a diagram illustrating an example of a transition in the recording of edit items when the one or more embodiments are not used. The image is edited, and the recording of the edit items transitions in the order of states 601, 602, 603, and 604. In the states 601, 602, 603, and 604, the items that have been edited are recorded in a recording region 1. In the example illustrated in FIG. 6, in the state 601, edit items in which the HDR setting is off, and the RGB tone curve, white balance (WB), picture style, and luminance noise reduction (luminance noise NR) are recorded in a region 605. When transitioning from the state 601 to the state 602, an edit is made in which the HDR setting is set to off. At this time, the RGB tone curve, which is an edit item that results in an image having different properties between the SDR environment and the HDR environment, is reset. When transitioning from the state 602 to the state 603, processing for setting the brightness adjustment to +2 is performed as the image editing. Of the edit items, the brightness adjustment is not an edit item that results in an image having different properties between the HDR environment and the SDR environment. When transitioning from the state 603 to the state 604, the HDR setting reverts to off. For this reason, the HDR setting is turned from off, to on, and then back to off in the time from the state 601 to the state 604, but the RGB tone curve that has been reset in the state 602 remains reset in the state 604.

Accordingly, in the embodiment example illustrated in FIG. 6, when the HDR setting for development has reverted from the SDR state to the SDR state having changed to the HDR state in between, the RGB tone curve used in the original state is not applied to the image. It is therefore necessary for the user to apply the RGB tone curve again to restore that setting, which is troublesome for the user. There are also cases where the user is unable to ascertain the appropriate RGB tone curve, and thus appropriate image processing cannot be implemented. Accordingly, the one or more embodiments of the present disclosure solve such issues or avoid such inefficiencies for the user, for processing such state changes, and/or for the devices of the present disclosure to the greatest extent possible.

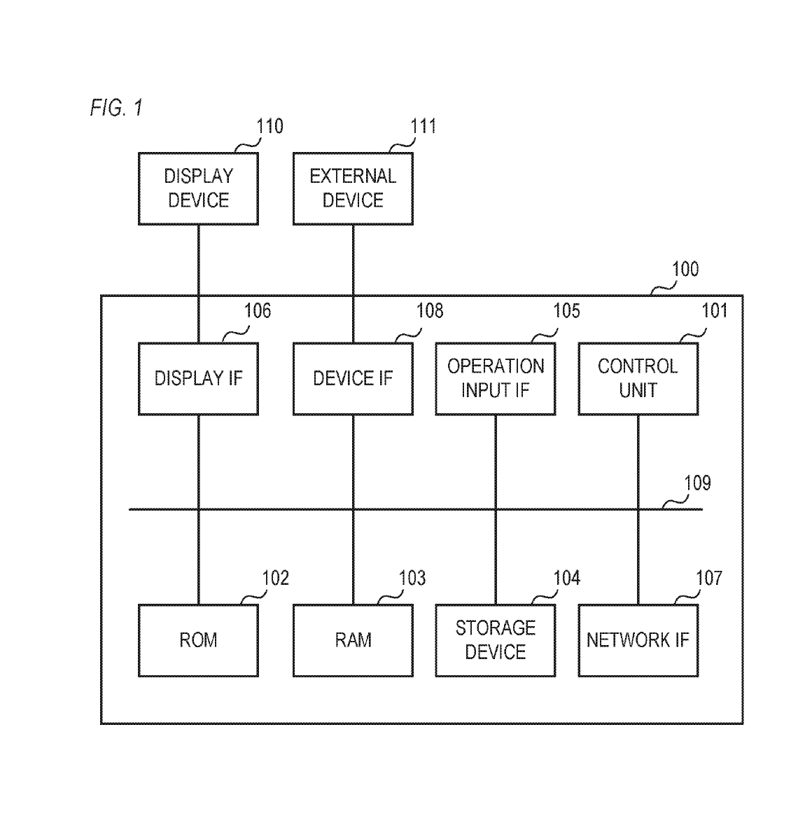

FIG. 1 is a diagram illustrating an example of the configuration of an image editing device or an electronic device 100 according to one or more embodiments of the present disclosure. The image editing or the electronic device 100 includes a control unit 101, a read-only memory (ROM) 102, a random access memory (RAM) 103, a storage device 104, an operation input IF 105, a display IF 106, a network IF 107, a device IF 108, and a system bus 109.

The control unit 101 controls the image editing device or the electronic device 100 as a whole. For example, the control unit 101 is a central processing unit (CPU) or a graphics processing unit (GPU).

The ROM 102 stores various data (such as programs and parameters) in a non-temporary state.

The RAM 103 temporarily stores various types of data.

The storage device 104 is a semiconductor memory or a hard disk, for example. The storage device 104 stores various types of data in a non-temporary state. The storage device 104 may or may not be removable from the image editing device or the electronic device 100.

The operation input IF 105 is an interface with an input device (such as a mouse or keyboard).

The display IF 106 is an interface with a display device 110 for displaying various types of images.

The network IF 107 is an interface for connecting the image editing device or the electronic device 100 to a network line such as the Internet.

The device IF 108 is an interface for communicating with an external device 111 such as an image capturing device.

The system bus 109 is a bus that communicably connects these elements (the control unit 101, the ROM 102, the RAM 103, the storage device 104, the operation input IF 105, the display IF 106, the network IF 107, and the device IF 108) to each other.

A liquid crystal panel and a backlight module, or an organic electroluminescence (EL) panel, for example, can be used for the display device 110.

In one or more embodiments, the control unit 101 starts an image editing application or software program stored in the storage device 104, and causes the foregoing elements to operate in accordance therewith. As a result, the control unit 101 reads out an image file from the storage device 104 and executes image processing. The image processing includes processing for developing RAW image data by adjusting parameters (such as exposure, white balance, and the like), processing for rotating or cropping the image, and the like.

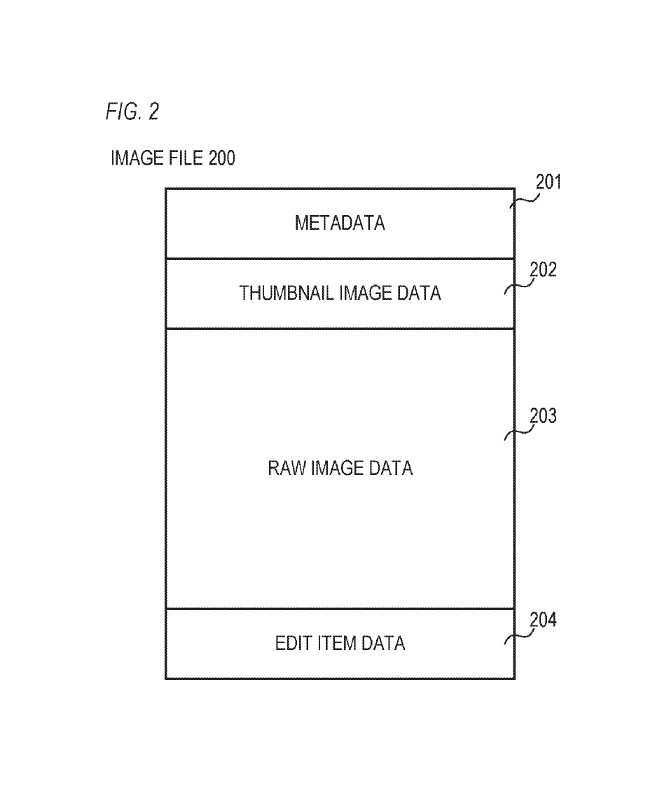

FIG. 2 is a block diagram illustrating an example of a configuration of an image file 200 according to one or more embodiments. The image file 200 includes metadata 201, thumbnail image data 202, RAW image data 203, and edit item data 204.

The metadata 201 is data indicating attributes of the image file 200 (a filename, a file creation date/time, a shooting date/time, a file size, and the like).

The thumbnail image data 202 is data in which an image signal obtained through image capturing processing is subjected to development processing, and the resulting image signal is then encoded in JPEG format.

The RAW image data 203 is unprocessed data in which development processing has not been performed on an image signal obtained through image capturing processing.

The edit item data 204 is data that holds items for a sequence of editing processing performed on the RAW image data (edit items) and parameters. The items in the editing processing are, for example, brightness adjustment, white balance, cropping, and the like. In one or more embodiments, the edit item data 204 may be stored in the image file 200, or may be stored in the storage device 104 separately from the image file 200.

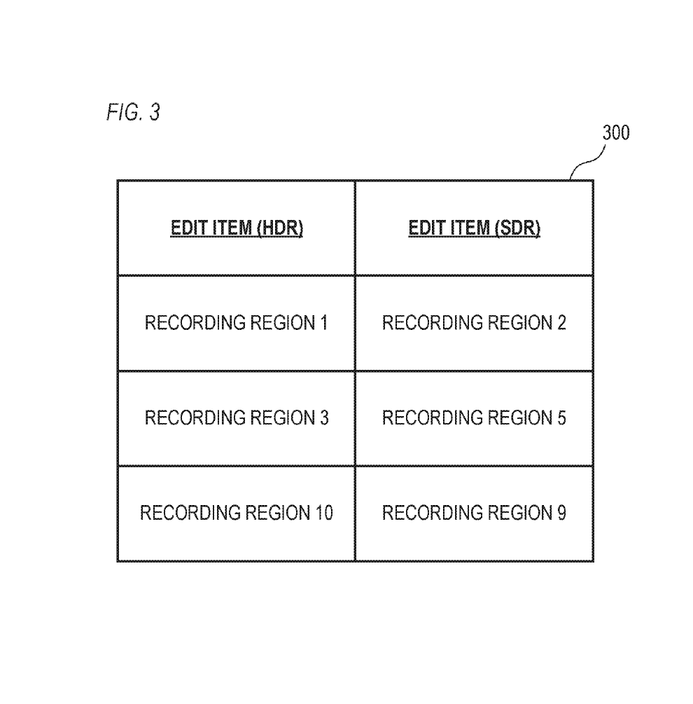

An example of recording an item for editing to be applied to an image (an edit item), in association with a case where the HDR setting for development (the developing mode) is HDR and the HDR setting for development is SDR (a recording control method), will be described with reference to FIG. 3.

FIG. 3 illustrates a table 300 in which edit items for a case where the HDR setting for development is HDR and edit items for a case where the HDR setting for development is SDR are associated. The edit items are recorded in each of recording regions. When the setting for development is HDR, an edit item 301 applied to the image when generating an HDR image is registered in one of recording regions 1, 3, and 10. When the setting for development is SDR, an edit item applied to the image when generating an SDR image is registered in one of recording regions 2, 5, and 9.

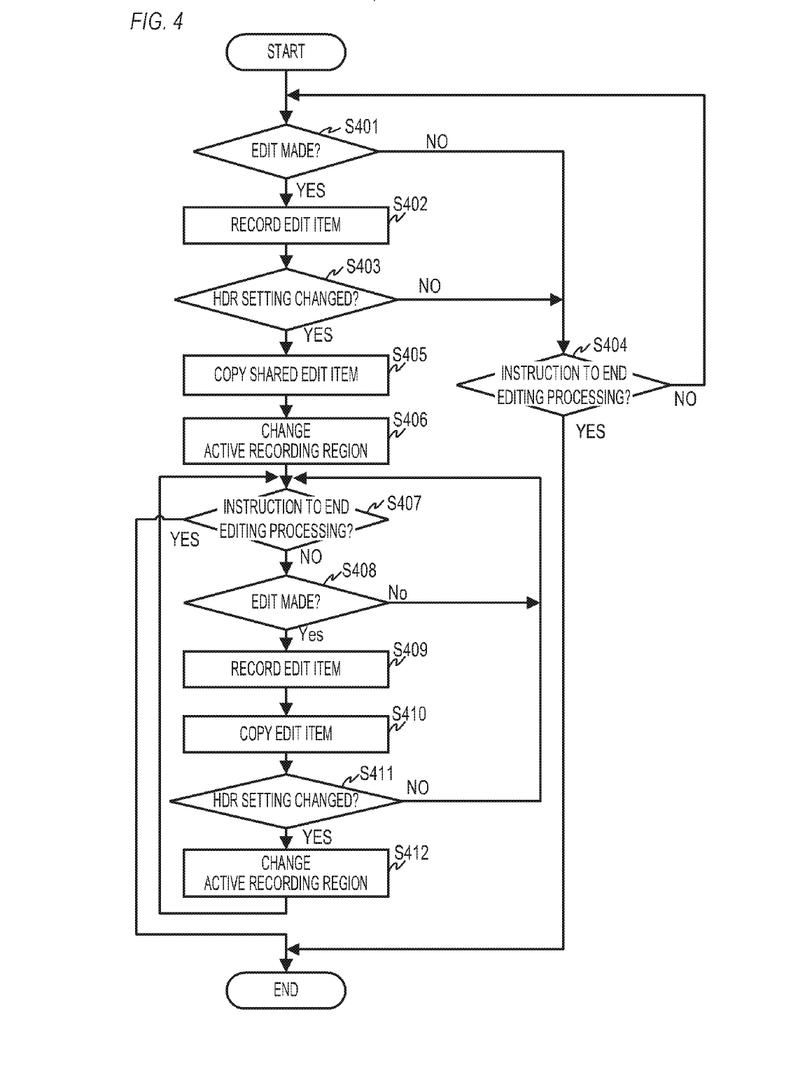

Processing performed by the image editing device or electronic device 100 will be described with reference to the flowchart in FIG. 4.

In step S401, the control unit 101 determines whether the image has been edited (image adjustment). If the image is determined to have been edited, the sequence moves to step S402. If the image is determined not to have been edited, the sequence moves to step S404.

In step S402, the control unit 101 records the items of the editing performed on the image (the type of editing) into an active recording region (a recording region referenced during the processing).

In step S403, the control unit 101 determines whether the HDR setting for development (the current developing mode) has been changed (switched). If the HDR setting for development is determined to have been changed, the sequence moves to step S405. If the HDR setting for development is determined not to have been changed, the sequence moves to step S404.

In step S404, the control unit 101 determines whether an instruction to end the editing has been made. If the instruction to end the editing is determined not to have been made, the sequence moves to step S401. If the instruction to end the editing is determined to have been made, the processing of this flowchart ends.

In step S405, the control unit 101 copies (applies) a shared edit item, among the edit items applied to the image before changing the HDR setting for development, to a corresponding region that corresponds to the post-change HDR setting for development (another recording region corresponding to the active recording region). The shared edit item is an edit item that can be shared (applied to an image in common) between when the setting for development is HDR and when the setting for development is SDR. A recording region is provided for each HDR setting for development. At this time, the control unit 101 records the item with the copy source recording region and the copy destination recording region associated as in the table 300 in FIG. 3. When copying the shared edit item, the control unit 101 secures a free recording region and records the item into the free recording region. For example, in the example in FIG. 3, the recording region 1 corresponds to the recording region 2, and the recording region 5 corresponds to the recording region 3. For example, if the HDR setting for development is set from off (SDR) to on (HDR) in the state 601 illustrated in FIG. 6, the control unit 101 copies shared edit items, such as white balance (WB), picture style, and luminance noise reduction (luminance noise NR), to the corresponding region. On the other hand, the control unit 101 does not copy the RGB tone curve, which is one of the edit items, to the corresponding region, because doing so would cause the characteristics of the image to change between when HDR for development is set to off and when HDR for development is set to on. Note that “picture style” is a filter effect such as sharpness, contrast, color intensity, color tint, or black and white.

Note that when a corresponding region corresponding to the active recording region is present in the table 300 in FIG. 3 (i.e., when the corresponding region is already secured), the control unit 101 copies the shared edit item to that corresponding region. Accordingly, in this case, the control unit 101 does not secure a new recording region for the copying.

In step S406, the control unit 101 changes the active recording region. Specifically, the control unit 101 uses the corresponding region corresponding to the active recording region as a new active recording region. Referring to the table 300, the control unit 101 updates the active recording region to correspond to the post-change HDR setting for development. Note that the correspondence relationship between the information in the copy source recording region and the information in the copy destination recording region is recorded in the table 300 in FIG. 3.

For example, if the HDR setting for development is switched from off to on in the state 601 in FIG. 6, referring to the table 300 in FIG. 3, the control unit 101 changes the active recording region from the recording region 1 to the recording region 2. At this time, the edit items (adjustment parameters) that result in the image having different properties between the SDR environment and the HDR environment are recorded in two recording regions, one for the case where the HDR setting for development is on (HDR) and one for the case where the HDR setting for development is off (SDR), in steps S405 and S406. Accordingly, even if the HDR setting is reverted to off (SDR) after having been changed to on (HDR) from the state 601 in FIG. 6, operations for re-doing the editing can be omitted if the control unit 101 loads the edit items recorded in the recording region 1 and uses those edit items on the image.

In step S407, the control unit 101 determines whether an instruction to end the editing has been made. If the instruction to end the editing is determined not to have been made, the sequence moves to step S408. If the instruction to end the editing is determined to have been made, the processing of this flowchart ends.

In step S408, the control unit 101 determines whether the image has been edited. If the image is determined to have been edited, the sequence moves to step S409. If the image is determined not to have been edited, the sequence moves to step S407.

In step S409, the control unit 101 records the items of the editing performed on the image into the active recording region.

In step S410, if the edit item recorded in step S409 is a shared edit item, the control unit 101 copies the edit item to a corresponding region corresponding to the active recording region. Through the processing of step S410, the settings of the items for the editing performed in step S408 can be carried over even if the HDR setting for development is switched. Accordingly, the user need not perform operations for editing the edit items again after switching the HDR setting for development.

In step S411, the control unit 101 determines whether the HDR setting for development (the current developing mode) has been changed (switched). If the HDR setting for development is determined to have been changed, the sequence moves to step S412. If the HDR setting for development is determined not to have been changed, the sequence moves to step S407.

In step S412, the control unit 101 changes the active recording region to correspond to the post-change HDR setting for development. Specifically, the control unit 101 changes the corresponding region corresponding to the active recording region to a new active recording region. The specific processing performed in step S412 is the same as that performed in step S406.

In one or more embodiments, in step S405, when the HDR setting for development is switched, the control unit 101 copies the shared edit item to the corresponding region. However, the control unit 101 may secure the corresponding region and copy the shared edit item to the corresponding region at the timing when the image is loaded for editing, or at the timing when the image is edited.

Additionally, in one or more embodiments, the control unit 101 records the shared edit item for both the case where the HDR setting for development is HDR and the case where the HDR setting is SDR. However, the control unit 101 may record the shared edit item in common, and record edit items other than the shared edit item separately.

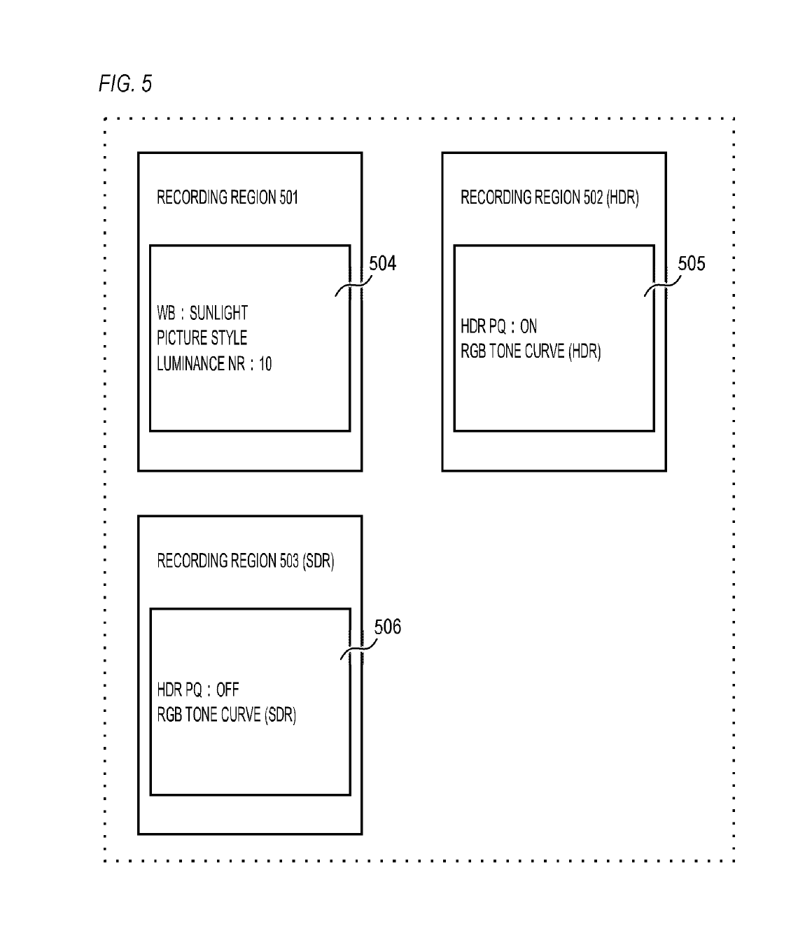

The following will describe, with reference to FIG. 5, a recording method for recording edit items other than the shared edit item separately. In a recording area 501, white balance (WB), picture style, and luminance noise reduction (luminance noise NR) are recorded as shared edit items 504. In a recording region 502, the HDR setting being on and an RGB tone curve (HDR) are recorded as edit items 505 for when the HDR setting for development is HDR. In a recording region 503, the HDR setting being off and an RGB tone curve (SDR) are recorded as edit items 506 for when the setting for development is SDR.

Although at least one embodiment of the one or more embodiments describes limiting the HDR setting for development to HDR and SDR, the configuration/embodiments need not be limited thereto. The HDR setting for development may include, for example, HDR (Hybrid Log-Gamma (HLG)) development or the like.

According to one or more embodiments, when editing an image, it is no longer necessary to re-edit the image even if the HDR setting for development (the developing mode) is reverted to a first mode after having been switched from the first mode to a second mode.

Additionally, in the above, the phrase “when A is equal to or greater than B, the processing proceeds to step S1, and when A is less than (lower than) B, the processing proceeds to step S2” may alternatively be construed as “when A is greater than (higher than) B, the processing proceeds to step S1, and when A is equal to or less than B, the processing proceeds to step S2.” Conversely, the phrase “when A is greater than (higher than) B, the processing proceeds to step S1, and when A is equal to or less than B, the processing proceeds to step S2” may alternatively be construed as “when A is equal to or greater than B, the processing proceeds to step S1, and when A is less than (lower than) B, the processing proceeds to step S2.” Accordingly, unless contradiction arises, the phrase “equal to or greater than A” may be construed as “greater than (higher than; longer than; more than) A,” and the phrase “equal to or less than A” may be construed as “less than (lower than; shorter than; fewer than) A.” Similarly, the phrase “greater than (higher than; longer than; more than) A” may be construed as “equal to or greater than A,” and the phrase “less than (lower than; shorter than; fewer than) A” may be construed as “equal to or less than A.”

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The at least one embodiment described above (including variation examples) is merely an example. Any configurations obtained by suitably modifying or changing some configurations of the at least one embodiment within the scope of the subject matter of the present disclosure are also included in the present disclosure. The present disclosure also includes other configurations obtained by suitably combining various features of the at least one embodiment.

According to the present disclosure, an image in which more appropriate image adjustments have been made can be provided more easily, even when a setting for development is switched.

### Other Embodiments

Embodiment(s) of the present disclosure may also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to, and the benefit of, Japanese Patent Application No. 2025-003440, filed January 9, 2025, which is hereby incorporated by reference herein in its entirety.

What is claimed is:

1. An image editing device comprising:
one or more processors that operate to:
execute an editing processing of editing an image in a current developing mode;
execute a changing processing of changing the current developing mode to any of a plurality of modes;
execute a recording control processing of recording, into a recording region corresponding to the current developing mode, an edit item of editing performed in the current developing mode; and
in a case where the plurality of modes include a mode that uses the edit item on the image in common with the current developing mode, execute an application processing of applying the edit item also to a recording region corresponding to the mode that uses the edit item.

2. The image editing device according to claim 1,
wherein the plurality of modes include at least any of the following: a mode of Standard Dynamic Range (SDR) development, a mode of High Dynamic Range (HDR) Perceptual Quantization (PQ) development, and a mode of HDR Hybrid Log-Gamma (HLG) development.

3. The image editing device according to claim 1,
wherein a recording region is assigned to each of the plurality of modes.

4. The image editing device according to claim 1,
wherein the one or more processors further operate to execute a securing processing of, in a case where the current developing mode is changed, securing the recording region corresponding to the current developing mode after the change.

5. The image editing device according to claim 4,
wherein in the securing processing, in a case where the current developing mode is changed, and in a case where the recording region corresponding to the current developing mode after the change is already present, the recording region corresponding to the current developing mode after the change is not newly secured.

6. The image editing device according to claim 1,
wherein in the application processing, in a case where the image is edited in the current developing mode, and in the case where the plurality of modes include the mode that uses the edit item on the image in common with the current developing mode, the edit item is applied to the recording region corresponding to the mode that uses the edit item.

7. The image editing device according to claim 1,
wherein a correspondence relationship between a plurality of recording regions corresponding to the plurality of modes is recorded.

8. The image editing device according to claim 1,
wherein the edit item is a white balance item, a picture style item, or a luminance noise reduction item.

9. The image editing device according to claim 1,
wherein in the current developing mode, processing is performed with reference to the recording region corresponding to the current developing mode.

10. The image editing device according to claim 1,
wherein in the application processing, the edit item is not applied to a recording region corresponding to a mode that does not use the edit item on the image in common with the current developing mode from among the plurality of modes.

11. An image editing device comprising:
one or more processors that operate to:
execute an editing processing of editing an image in a current developing mode;
execute a changing processing of changing the current developing mode to any of a plurality of modes; and
execute a recording control processing of 1) in a case where an edit item for editing performed in the current developing mode is not used on the image in common in the plurality of modes, recording the edit item into a first recording region corresponding to the current developing mode, and 2) in a case where the edit item is used on the image in common in the plurality of modes, recording the edit item into a second recording region.

12. A control method for an image editing device, the control method comprising:
editing an image in a current developing mode;
changing the current developing mode to any of a plurality of modes;
recording, into a recording region corresponding to the current developing mode, an edit item of editing performed in the current developing mode; and
in a case where the plurality of modes include a mode that uses the edit item on the image in common with the current developing mode, applying the edit item also to a recording region corresponding to the mode that uses the edit item.

13. A non-transitory computer readable medium that stores a program, wherein the program causes a computer to execute the control method according to claim 12.
